(19) United States
(12) Patent Application Publication
(10) Pub. No.: US 2025/0317868 A1
(43) Pub. Date: Oct. 9, 2025

(54) Transmission Method and Terminal, and Network Side Device

(71) Applicant: VIVO MOBILE COMMUNICATION CO.,LTD., Dongguan (CN)

(72) Inventors: Yinhui Liu, Dongguan (CN); Gen Li, Dongguan (CN); Zichao Ji, Dongguan (CN)

(21) Appl. No.: 19/243,235

(22) Filed: Jun. 19, 2025

Related U.S. Application Data
(63) Continuation of application No. PCT/CN2023/139470, filed on Dec. 18, 2023.

(30) Foreign Application Priority Data
Dec. 21, 2022 (CN) 202211652777.7

(51) Int. Cl. H04W 52/24; H04W 4/70; H04W 24/08

(52) U.S. Cl. CPC H04W 52/24; H04W 4/70; H04W 24/08

(57) ABSTRACT

A transmission method, which includes determining, by a first device, a first adjustment amount based on first information, the first adjustment amount being used for adjusting a power spectral density of the first device; determining, by the first device, a target power spectral density based on the first adjustment amount and first power spectral density information, the first power spectral density information being related to the power spectral density of the first device; and performing, by the first device, target transmission with a second device based on the target power spectral density. The first information satisfies at least one of the following; being obtained based on a result of measurement performed on a transmission resource of the target transmission, or being obtained by using information carried by signaling.

### CROSS-REFERENCE TO RELATED APPLICATIONS

This application is a Bypass Continuation application of International Patent Application No. PCT/CN2023/139470 filed Dec. 18, 2023, and claims priority to Chinese Patent Application No. 202211652777.7, filed Dec. 21, 2022, the disclosures of which are hereby incorporated by reference in their entireties.

### BACKGROUND OF THE INVENTION

### Field of the Invention

This application belongs to the field of communication technologies, and to a transmission method and terminal, and a network side device.

### Description of Related Art

At present, device to device (D2D) communication may be used to enable data to be directly transmitted between two terminals (also referred to as user equipment (UE)) without forwarding the data through a network side device.

In a case that an authorized spectrum is used for the D2D communication, the network side device may configure a time-frequency resource in a resource pool for the D2D communication, and may also configure the time-frequency resource in the resource pool for Uu communication in which another terminal performs transmission through a user to network universal (Uu) interface.

### SUMMARY OF THE INVENTION

Embodiments of this application provide a transmission method and terminal, and a network side device.

According to a first aspect, a transmission method is provided and is applied to a first device, and the method includes: determining, by a first device, a first adjustment amount based on first information, the first adjustment amount being used for adjusting a power spectral density of the first device; determining, by the first device, a target power spectral density based on the first adjustment amount and first power spectral density information, the first power spectral density information being related to the power spectral density of the first device; and performing, by the first device, target transmission with a second device based on the target power spectral density. The first information satisfies at least one of the following: being obtained based on a result of measurement performed on a transmission resource of the target transmission, or being obtained by using information carried by signaling.

According to a second aspect, a transmission apparatus is provided, the transmission apparatus is a first transmission apparatus, and the first transmission apparatus includes a determining module and a transmission module. The determining module is configured to: determine a first adjustment amount based on first information, the first adjustment amount being used for adjusting a power spectral density of the first transmission apparatus; and determine a target power spectral density based on the first adjustment amount and first power spectral density information, the first power spectral density information being related to the power spectral density of the first transmission apparatus. The transmission module is configured to perform target transmission with a second transmission apparatus based on the target power spectral density determined by the determining module. The first information satisfies at least one of the following: being obtained based on a result of measurement performed on a transmission resource of the target transmission, or being obtained by using information carried by signaling.

According to a third aspect, a transmission method is provided and is applied to a target device, and the method includes: sending, by the target device, signaling to a first device, the signaling carrying first information, and the first information being used for determining a first adjustment amount. The first adjustment amount is used for adjusting a power spectral density of the first device, to make the first device perform target transmission with a second device, and the target device is any one of the following: the second device, a network side device, and a third device.

According to a fourth aspect, a transmission apparatus is provided, the transmission apparatus is a target transmission apparatus, and the target transmission apparatus includes a sending module. The sending module is configured to send signaling to a first transmission apparatus, the signaling carries first information, and the first information is used for determining a first adjustment amount. The first adjustment amount is used for adjusting a power spectral density of the first transmission apparatus, to perform target transmission with a second transmission apparatus, and the target transmission apparatus is any one of the following: the second transmission apparatus, a network side device, and a third transmission apparatus.

According to a fifth aspect, a terminal is provided, the terminal includes a processor and a memory, the memory stores a program or an instruction that can be run on the processor, and when the program or the instruction is executed by the processor, the steps of the method according to the first aspect or the steps of the method according to the third aspect are implemented.

According to a sixth aspect, a terminal is provided, including a processor and a communication interface, where the processor is configured to: determine a first adjustment amount based on first information, the first adjustment amount being used for adjusting a power spectral density of the terminal; and determine a target power spectral density based on the first adjustment amount and first power spectral density information, the first power spectral density information being related to the power spectral density of the terminal; and the communication interface is configured to perform target transmission with a second terminal based on the target power spectral density. The first information satisfies at least one of the following: being obtained based on a result of measurement performed on a transmission resource of the target transmission, or being obtained by using information carried by signaling. Alternatively, the communication interface is configured to send signaling to a first terminal, the signaling carries first information, and the first information is used for determining a first adjustment amount. The first adjustment amount is used for adjusting a power spectral density of the first terminal, to perform target transmission with a second terminal, and the terminal is any one of the following: the second terminal and a third terminal.

According to a seventh aspect, a network side device is provided, the network side device includes a processor and a memory, the memory stores a program or an instruction that can be run on the processor, and when the program or the instruction is executed by the processor, the steps of the method according to the third aspect are implemented.

According to an eighth aspect, a network side device is provided, including a processor and a communication interface, where the communication interface is configured to send signaling to a first terminal, the signaling carries first information, and the first information is used for determining a first adjustment amount. The first adjustment amount is used for adjusting a power spectral density of the first terminal, to perform target transmission with the network side device.

According to a ninth aspect, an access point is provided, the access point includes a processor and a memory, the memory stores a program or an instruction that can be run on the processor, and when the program or the instruction is executed by the processor, the steps of the method according to the third aspect are implemented.

According to a tenth aspect, an access point is provided, including a processor and a communication interface, where the communication interface is configured to send signaling to a first terminal, the signaling carries first information, and the first information is used for determining a first adjustment amount. The first adjustment amount is used for adjusting a power spectral density of the first terminal, to perform target transmission with the access point.

According to an eleventh aspect, a transmission system is provided, including a first terminal and a target terminal, the first terminal may be configured to implement the steps of the method according to the first aspect, and the target terminal may be configured to implement the steps of the method according to the third aspect.

According to a twelfth aspect, a non-transitory readable storage medium is provided, the non-transitory readable storage medium stores a program or an instruction, and when the program or the instruction is executed by a processor, the steps of the method according to the first aspect are implemented, or the steps of the method according to the third aspect are implemented.

According to a thirteenth aspect, a chip is provided, the chip includes a processor and a communication interface, the communication interface is coupled to the processor, and the processor is configured to run a program or an instruction, to implement the steps of the method according to the first aspect or implement the steps of the method according to the third aspect.

According to a fourteenth aspect, a computer program/program product is provided, the computer program/program product is stored in a storage medium, and the computer program/program product is executed by at least one processor to implement the steps of the method according to the first aspect or implement the steps of the method according to the third aspect.

### BRIEF DESCRIPTION OF THE DRAWINGS

FIG. 1 is a block diagram of a wireless communication system according to an embodiment of this application;

FIG. 2 is a first schematic flowchart of a transmission method according to an embodiment of this application;

FIG. 3 is a second schematic flowchart of a transmission method according to an embodiment of this application;

FIG. 4 is a third schematic flowchart of a transmission method according to an embodiment of this application;

FIG. 5 is a fourth schematic flowchart of a transmission method according to an embodiment of this application;

FIG. 6 is a schematic diagram of a structure of a first transmission apparatus according to an embodiment of this application;

FIG. 7 is a schematic diagram of a structure of a target transmission apparatus according to an embodiment of this application;

FIG. 8 is a schematic diagram of a structure of a communication device according to an embodiment of this application;

FIG. 9 is a schematic diagram of a hardware structure of a terminal according to an embodiment of this application; and

FIG. 10 is a schematic diagram of a hardware structure of a network side device according to an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms in this application are described in the following:

### 1. Sidelink (SL) Transmission

Generally, the SL transmission refers to direct data transmission between a terminal and another terminal on a physical layer. In a Long Term Evolution (LTE) system, the SL transmission performs communication via broadcasting. Although being applicable to basic safety-related communication that supports vehicle to everything (V2X), the SL transmission is inapplicable to other V2X services of a higher level. A New Radio (NR) system supports more advanced designs of SL transmission, such as unicast, broadcast, groupcast, or the like, thereby supporting services of more comprehensive types.

### 2. Channel Busy Ratio (CBR)

The CBR is one of basic measurement amounts used for supporting congestion control. The CBR is defined as: within a CBR measurement window [n−c, n−1], a proportion of subchannels with SL received signal strength indication (RSSI) higher than a configured threshold to a total quantity of subchannels in a resource pool, where c is 100 slots or 100·2^{u} slots.

### 3. Channel Occupancy Ratio (CR)

The CR is one of basic measurement amounts used for supporting congestion control. The CR is defined as: a proportion of a quantity of subchannels that the terminal has used to send data in a range of [n−a, n−1] and a quantity of subchannels that included in an obtained lateral grant in a range of [n, n+b] to a total quantity of subchannels belonging to a resource pool in a range of [n−a, n+b], and the CR may be calculated separately for different priorities.

a is a positive integer, b is 0 or a positive integer, and values of a and b are determined by the terminal.

### 4. Other Terms

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the NR terminology is used in most of the following description, although these technologies can also be applied to applications other than the NR system application, such as the 6^{th} generation (6G) communication system.

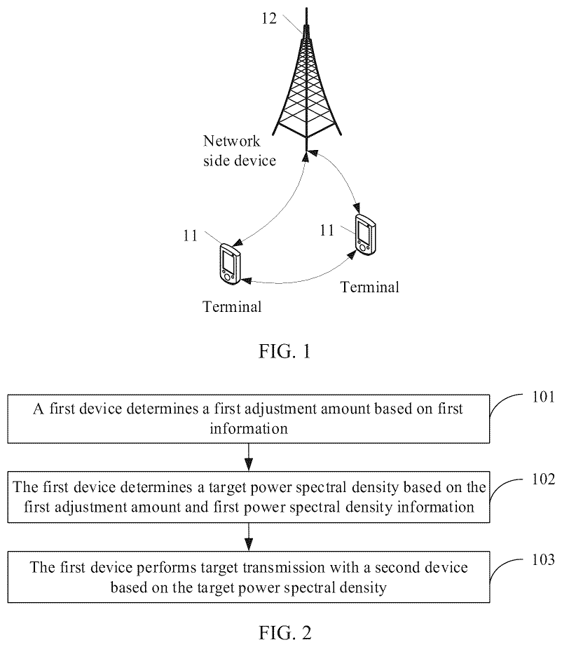

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a radio access network (RAN), a radio access network function, or a radio access network unit. The access network device 12 may include a base station, a micro base station, a pico base station, a WLAN access node, a Wi-Fi node, or the like. The base station may be referred to as a NodeB (NB), an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

The following describes in detail the transmission method and apparatus, and the related product provided in the embodiments of this application through some embodiments and application scenarios thereof with reference to the accompanying drawings.

Usually, the network side device may configure an overlapping time-frequency resource for the D2D communication and the Uu communication in which the another terminal performs transmission through the Uu interface. In this case, to ensure performance of the Uu communication, a power spectral density of the D2D communication may be excessively limited. On the premise of ensuring the performance of the Uu communication, how to improve the power spectral density of the D2D communication is very important for transmission performance of the D2D communication.

In the embodiments of this application, the first device may first determine the first adjustment amount based on the first information, and then determine the target power spectral density based on the first adjustment amount and the first power spectral density information related to the power spectral density of the first device, so that the first device may perform target transmission with the second device based on the target power spectral density, where the first information satisfies at least one of the following: being obtained based on a result of measurement performed on a transmission resource of target transmission, or being obtained by using information carried by signaling. Because the first information is obtained based on the result of measurement performed on the transmission resource of the target transmission, and the result is related to Uu communication (transmission resources of the Uu communication at least partially overlap with transmission resources of the target transmission), the first device may determine a proper first adjustment amount based on the first information, and determine a proper target power spectral density based on the proper first adjustment amount and first power spectral density information. In this way, the first device may perform target transmission with the second device based on the proper target power spectral density, to reduce interference to the Uu communication; and/or because the first information is obtained by using the information carried by signaling, that is, the first device may determine a proper first adjustment amount based on indication of the information, and determine a proper target power spectral density based on the proper first adjustment amount and the first power spectral density information. In this way, the first device may perform target transmission with the second device based on the proper target power spectral density, to reduce interference to the Uu communication. In this way, transmission performance of the target transmission may be improved on the premise of ensuring performance of the Uu communication.

FIG. 2 is a flowchart of a transmission method according to an embodiment of this application. As shown in FIG. 2, the transmission method provided in the embodiments of this application may include the following step 101 to step 103.

Step 101: A first device determines a first adjustment amount based on first information.

In this embodiment of this application, the first information satisfies at least one of the following: being obtained based on a result of measurement performed on a transmission resource of target transmission, or being obtained by using information carried by signaling.

Optionally, in this embodiment of this application, the target transmission may be one of the following wireless signals: 4th-generation mobile communication technology (4G), 5th-generation mobile communication technology (5G), 6th-generation mobile communication technology (6G), wireless fidelity (Wi-Fi), ultra wideband (UWB), heterogeneous network (HetNet), or other user-defined interface transmission.

Optionally, in this embodiment of this application, the transmission resource may include at least one of the following: a time domain resource or a frequency domain resource.

Optionally, in this embodiment of this application, in a case that the first device receives configuration information of the target transmission from the network side device, the first device may perform measurement on the transmission resources of the target transmission in the configuration information, to obtain the first information, and/or, the first device may receive signaling from another device and obtain the first information based on information carried by the signaling.

In this embodiment of this application, the first adjustment amount is used for adjusting a power spectral density of the first device.

Optionally, in this embodiment of this application, the first adjustment amount includes at least one of the following: a power spectral density adjustment amount or a power spectral density limit adjustment amount. The power spectral density adjustment amount is used for adjusting the power spectral density of the first device; and the power spectral density limit adjustment amount is used for adjusting an upper limit or a lower limit of the power spectral density of the first device.

Optionally, in this embodiment of this application, the first adjustment amount may include one or more adjustment amounts.

Optionally, in this embodiment of this application, the first device may first determine a corresponding preset value based on the first information, and determine the first adjustment amount as the preset value; or the first device may directly determine the first adjustment amount as an adjustment amount corresponding to the first information.

Step 102: The first device determines a target power spectral density based on the first adjustment amount and first power spectral density information.

In this embodiment of this application, the first power spectral density information is related to the power spectral density of the first device.

Optionally, in this embodiment of this application, the first power spectral density information includes at least one of the following:
a second power spectral density;
a lowest value of power spectral density limit of the first device; or
a highest value of the power spectral density limit of the first device.

In this embodiment of this application, the second power spectral density is a power spectral density of latest transmission between the first device and a second device.

The lowest value of the power spectral density limit of the first device may be understood as a lower limit of the power spectral density limit of the first device; and the highest value of the power spectral density limit of the first device may be understood as an upper limit of the power spectral density limit of the first device.

Optionally, in this embodiment of this application, the first power spectral density information may include one piece of power spectral density information in a case that the first adjustment amount includes one adjustment amount; and the first power spectral density information may include a plurality of pieces of power spectral density information in a case that the first adjustment amount includes a plurality of adjustment amounts.

Optionally, in this embodiment of this application, the first device may determine a target power spectral density based on the first adjustment amount and the first power spectral density information by using a first preset algorithm. The preset algorithm may include a first preset algorithm and a second preset algorithm.

In a case that the first adjustment amount includes the power spectral density adjustment amount, the first device may determine the target power spectral density based on the power spectral density adjustment amount and the first power spectral density information by using the first preset algorithm.

The first preset algorithm may be: pwd(n)=max(min(pwd(n−1)+psdDelta, pwdMax), pwdMin).

pwd(n) is the target power spectral density, pwd(n−1) is the second power spectral density, psdDelta is the power spectral density adjustment amount, pwdMax is the highest value of power spectral density limit of the first device, and pwdMin is the lowest value of the power spectral density limit of the first device.

In a case that the first adjustment amount includes the power spectral density limit adjustment amount, the first device may determine the target power spectral density based on the power spectral density limit adjustment amount and the first power spectral density information by using the second preset algorithm.

In an example, the power spectral density limit adjustment amount is used for adjusting the upper limit of the power spectral density of the first device. In this case, the second preset algorithm may be: pwd(n)=max(min(pwd(n−1), pwdMax+psdDelta), pwdMin).

Herein, pwd(n) is the target power spectral density, pwd(n−1) is the second power spectral density, psdDelta is the power spectral density limit adjustment amount (the power spectral density limit adjustment amount is used for adjusting the upper limit of the power spectral density of the first device), pwdMax is the highest value of power spectral density limit of the first device, and pwdMin is the lowest value of the power spectral density limit of the first device.

In another example, the power spectral density limit adjustment amount is used for adjusting the lower limit of the power spectral density of the first device. In this case, the second preset algorithm may be: pwd(n)=max(min(pwd(n−1), pwdMax), pwdMin+psdDelta).

Herein, pwd(n) is the target power spectral density, pwd(n−1) is the second power spectral density, psdDelta is the power spectral density limit adjustment amount (the power spectral density limit adjustment amount is used for adjusting the lower limit of the power spectral density of the first device), pwdMax is the highest value of the power spectral density limit of the first device, and pwdMin is the lowest value of the power spectral density limit of the first device.

Optionally, in this embodiment of this application, in a case that the first adjustment amount includes a plurality of adjustment amounts, and the first power spectral density information includes a plurality of pieces of power spectral density information, the first device may determine a power spectral density based on each adjustment amount and each power spectral density information by using a preset algorithm, to obtain a plurality of power spectral densities, to obtain the target power spectral density.

It can be understood that in a case that the first adjustment amount includes a plurality of adjustment amounts, and the first power spectral density information includes a plurality of pieces of power spectral density information, the target power spectral density may include a plurality of power spectral densities.

Step 103: The first device performs target transmission with the second device based on the target power spectral density.

Optionally, in this embodiment of this application, the first device may adjust the power spectral density of the first device to the target power spectral density and perform target transmission with the second device.

In this embodiment of this application, because time-frequency resources in Uu communication may at least partially overlap with time-frequency resources in the target transmission when the terminal performs target transmission, the terminal may determine a proper power spectral density based on the first information, and perform target transmission with the second device based on the proper target power spectral density, to reduce interference to the Uu communication, so that the target transmission and the Uu communication can share the time-frequency resources.

According to the transmission method provided in this embodiment of this application, the first device may first determine the first adjustment amount based on the first information, and then determine the target power spectral density based on the first adjustment amount and the first power spectral density information related to the power spectral density of the first device, so that the first device may perform target transmission with the second device based on the target power spectral density, where the first information satisfies at least one of the following: being obtained based on a result of measurement performed on a transmission resource of target transmission, or being obtained by using information carried by signaling. Because the first information is obtained based on the result of measurement performed on the transmission resource of the target transmission, and the result is related to Uu communication (transmission resources of the Uu communication at least partially overlap with transmission resources of the target transmission), the first device may determine a proper first adjustment amount based on the first information, and determine a proper target power spectral density based on the proper first adjustment amount and first power spectral density information. In this way, the first device may perform target transmission with the second device based on the proper target power spectral density, to reduce interference to the Uu communication; and/or because the first information is obtained by using the information carried by signaling, that is, the first device may determine a proper first adjustment amount based on indication of the information, and determine a proper target power spectral density based on the proper first adjustment amount and the first power spectral density information. In this way, the first device may perform target transmission with the second device based on the proper target power spectral density, to reduce interference to the Uu communication. In this way, transmission performance of the target transmission may be improved on the premise of ensuring performance of the Uu communication.

The following uses examples in which the first information is different information to describe how the first device determines the first adjustment amount.

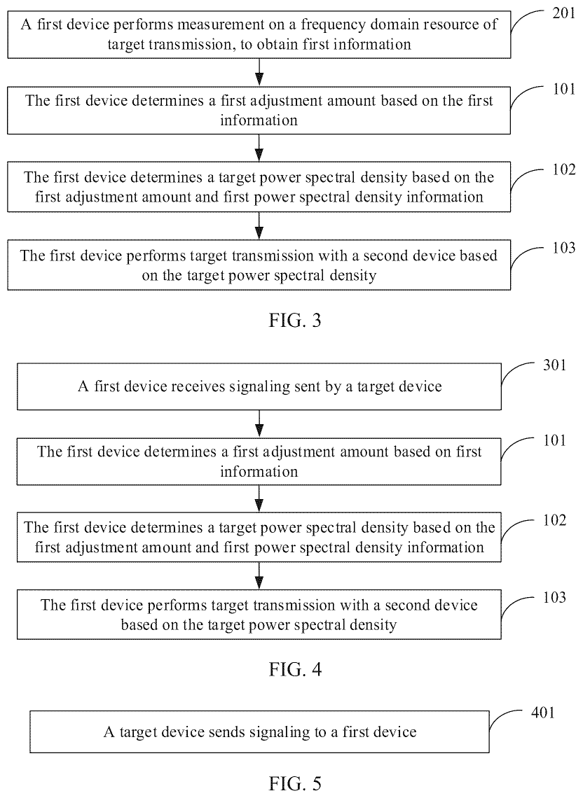

Optionally, in a possible implementation of this embodiment of this application, the first information is obtained based on the result of measurement performed on the transmission resource of the target transmission. Optionally, with reference to FIG. 2, as shown in FIG. 3, before the foregoing step 101, the transmission method provided in this embodiment of this application may further include the following step 201.

Step 201: The first device performs measurement on a frequency domain resource of the target transmission, to obtain the first information.

Optionally, in this embodiment of this application, the frequency domain resource may be at least one of the following: a resource block (RB), a subchannel, a resource pool, a bandwidth part (BWP), or a system bandwidth.

Optionally, in this embodiment of this application, in a case that the first device receives configuration information of the target transmission from the network side device, the first device may obtain a frequency domain resource of the target transmission from the configuration information, so that the first device may perform measurement on the frequency domain resource.

Optionally, in this embodiment of this application, the first information includes at least one of the following:
RSSI of the frequency domain resource of the target transmission;
CBR of the frequency domain resource of the target transmission;
beam matching information between the first device and the network side device;
sounding reference signal (SRS) signal strength;
synchronization signal and PBCH block (SSB) signal strength; or
channel state information reference signal (CSI-RS) signal strength.

The following uses an example in which the first information includes different information for description.

### Example 1

Optionally, in this embodiment of this application, the first information includes at least one of the following: the RSSI of the frequency domain resource of the target transmission, the CBR of the frequency domain resource of the target transmission, the signal strength of the SRS, the signal strength of the SSB, or the signal strength of the CSI-RS. Optionally, the foregoing step 101 may be implemented by using the following step 101a and step 101b.

Step 101a: In a case that the first information is less than or equal to a first threshold, the first device determines the first adjustment amount as a first preset value.

Optionally, in this embodiment of this application, the first threshold threshold1 may be a threshold specified by a protocol, a threshold configured by the network side device, a threshold preconfigured by the network side device, or a threshold defaulted by the first device.

Optionally, in this embodiment of this application, the first preset value psdDeltaValue1 may be a preset value specified by a protocol, a preset value configured by the network side device, a preset value preconfigured by the network side device, or a preset value defaulted by the first device. The first preset value psdDeltaValue1 is on a dB basis, and the first preset value psdDeltaValue1 is greater than 0.

In this embodiment of this application, if at least one of the RSSI of the frequency domain resource of the target transmission, the CBR of the frequency domain resource of the target transmission, the signal strength of the SRS, the signal strength of the SSB, or the signal strength of the CSI-RS is less than or equal to the first threshold, it can be considered that Uu communication in which time-frequency resources at least partially overlap with time-frequency resources of the target transmission may not exist. Therefore, the first device may determine the first adjustment amount as the first preset value, so that the target power spectral density determined based on the first adjustment amount is large.

It can be learned that because the first device may determine the first adjustment amount as the first preset value in a case that Uu communication in which time-frequency resources at least partially overlap with time-frequency resources of the target transmission does not exist, the target power spectral density determined based on the first adjustment amount is large. In this way, transmission performance of the target transmission may be improved.

Step 101b: In a case that the first information is greater than or equal to a second threshold, the first device determines the first adjustment amount as a second preset value.

Optionally, in this embodiment of this application, the second threshold threshold2 may be a threshold specified by a protocol, a threshold configured by the network side device, a threshold preconfigured by the network side device, or a threshold defaulted by the first device.

In this embodiment of this application, the second threshold threshold2 is greater than or equal to the first threshold threshold1.

In this embodiment of this application, the first preset value is greater than the second preset value.

Optionally, in this embodiment of this application, the second preset value psdDeltaValue2 may be a preset value specified by a protocol, a preset value configured by the network side device, a preset value preconfigured by the network side device, or a preset value defaulted by the first device. The second preset value psdDeltaValue2 is on a dB basis, and the second preset value psdDeltaValue2 is less than 0.

It can be understood that because the first preset value psdDeltaValue1 is greater than 0, and the second preset value psdDeltaValue2 is less than 0, the first preset value is greater than the second preset value.

In this embodiment of this application, if at least one of the RSSI of the frequency domain resource of the target transmission, the CBR of the frequency domain resource of the target transmission, the signal strength of the SRS, the signal strength of the SSB, or the signal strength of the CSI-RS is greater than or equal to the second threshold, it can be considered that Uu communication in which time-frequency resources at least partially overlap with time-frequency resources of the target transmission may exist. Therefore, the first device may determine the first adjustment amount as the second preset value, so that the target power spectral density determined based on the first adjustment amount is small.

It can be learned that because the first device may determine the first adjustment amount as the second preset value in a case that Uu communication in which time-frequency resources at least partially overlap with time-frequency resources of the target transmission exists, the target power spectral density determined based on the first adjustment amount is small. In this way, interference to the Uu communication may be reduced.

### Example 2

Optionally, in this embodiment of this application, the first information is the beam matching information; and the beam matching information indicates that an interference of the first device to the network side device in a first beam direction is greater than an interference of the first device to the network side device in a second beam direction. Optionally, the foregoing step 101 may be implemented by using the following step 101c or step 101d.

Step 101c: In a case that a beam direction of the target transmission is the first beam direction, the first device determines the first adjustment amount as a third preset value.

Optionally, in this embodiment of this application, the third preset value psdDeltaValue3 may be a preset value specified by a protocol, a preset value configured by the network side device, a preset value preconfigured by the network side device, or a preset value defaulted by the first device. The third preset value psdDeltaValue3 is less than 0.

In this embodiment of this application, if the interference of the first device to the network side device in the first beam direction is greater than the interference of the first device to the network side device in the second beam direction, it can be considered that the first beam direction may be opposite to a beam direction of the network side device. Therefore, the first device may determine the first adjustment amount as the third preset value, so that the target power spectral density determined based on the first adjustment amount is small.

It can be learned that because the first device may determine the first adjustment amount as the third preset value in a case that the beam direction of the target transmission is opposite to the beam direction of the network side device, the target power spectral density determined based on the first adjustment amount is small. In this way, interference to the Uu communication (transmission resources of the Uu communication at least partially overlap with transmission resources of the target transmission) may be reduced.

Step 101d: In a case that the beam direction of the target transmission is the second beam direction, the first device determines the first adjustment amount as a fourth preset value.

In this embodiment of this application, the third preset value is less than the fourth preset value.

Optionally, in this embodiment of this application, the fourth preset value psdDeltaValue4 may be a preset value specified by a protocol, a preset value configured by the network side device, a preset value preconfigured by the network side device, or a preset value defaulted by the first device. The fourth preset value psdDeltaValue4 is greater than 0.

In this embodiment of this application, if the interference of the first device to the network side device in the first beam direction is greater than the interference of the first device to the network side device in the second beam direction, it can be considered that the second beam direction may not be opposite to a beam direction of the network side device. Therefore, the first device may determine the first adjustment amount as the fourth preset value, so that the target power spectral density determined based on the first adjustment amount is large.

It can be learned that because the first device may determine the first adjustment amount as the fourth preset value in a case that the beam direction of the target transmission is not opposite to the beam direction of the network side device, the target power spectral density determined based on the first adjustment amount is large. In this way, transmission performance of the target transmission is improved.

Optionally, in another possible implementation of this embodiment of this application, the first information is obtained by using the information carried by signaling. Optionally, with reference to FIG. 2, as shown in FIG. 4, before the foregoing step 101, the transmission method provided in this embodiment of this application may further include the following step 301.

Step 301: A first device receives signaling sent by a target device.

In this embodiment of this application, the signaling carries first information. The target device is any one of the following: a second device, a network side device, and a third device.

Optionally, in this embodiment of this application, the signaling may include at least one of the following: radio resource control (RRC) signaling, medium access control (MAC) signaling, or physical layer signaling.

Optionally, in this embodiment of this application, the second device may be any one of the following: an access point and a terminal. The access point may be a micro base station, a pico base station, or the like.

Optionally, in this embodiment of this application, the third device may be a device related to Uu communication (transmission resources of the Uu communication at least partially overlap with transmission resources of the target transmission), or an unrelated device.

Optionally, in this embodiment of this application, the first information includes at least one of the following:
a second adjustment amount;
a first index;
a first bitmap;
a service volume of a service to be/being transmitted by target Uu transmission;
a priority of the target Uu transmission;
a service volume of a target service to be/being transmitted in the target Uu transmission; or
a first time unit sequence.

In this embodiment of this application, the second adjustment amount is used for adjusting the power spectral density; and the first index has a mapping relationship with the second adjustment amount.

Optionally, in this embodiment of this application, a plurality of mapping relationships between a plurality of indexes and a plurality of adjustment amounts may be specified by a protocol, each mapping relationship is a mapping relationship between one index and one adjustment amount, and the plurality of mapping relationships include a mapping relationship between the first index and the second adjustment amount, so that the second adjustment amount having a mapping relationship with the first index may be determined.

In this embodiment of this application, the first bitmap includes N bits, and N is a positive integer.

In this embodiment of this application, time domain resources of the target Uu transmission at least partially overlap with time domain resources of the target transmission. The target service is a service with a priority greater than or equal to a predetermined priority.

It can be understood that the target transmission may cause interference to the target Uu transmission.

Optionally, in this embodiment of this application, the predetermined priority may be a high priority.

In this embodiment of this application, the first time unit sequence includes X first time units, and X is a positive integer.

Optionally, in this embodiment of this application, the first time unit may be any of the following: a subframe, a wireless frame, a slot, a mini-slot, an orthogonal frequency division multiplexing (OFDM) symbol, and the like.

The following uses an example in which the first information includes different information for description.

### Example 3

Optionally, in this embodiment of this application, the first information includes any one of the following: a second adjustment amount and a first index. Optionally, the foregoing step 101 may be implemented by using the following step 101e.

Step 101e: The first device determines the first adjustment amount as the second adjustment amount.

Optionally, in this embodiment of this application, in a case that the first information includes the first index, the first device may first determine, based on the plurality of mapping relationships, a second adjustment amount that has a mapping relationship with the first index, and then determine the first adjustment amount as the second adjustment amount.

Optionally, in this embodiment of this application, the target device may be configured based on per UE, per frequency band, per carrier group, per carrier, per bandwidth part, per resource pool, per slot, or per symbol, so that the first device may determine the first adjustment amount as the second adjustment amount.

It can be learned that because the first device may directly determine the first adjustment amount as the second adjustment amount indicated by another device, the first device may determine a proper target power spectral density based on the first adjustment amount. In this way, the first device may perform target transmission with the second device based on the proper target power spectral density, to improve the transmission performance of the target transmission in a case of ensuring low interference to Uu communication (transmission resources of the Uu communication at least partially overlap with transmission resources of the target transmission).

### Example 4

Optionally, the first information includes the first bitmap; and every Y bits in the N bits corresponds to one second time unit, and Y is a positive integer. Every Y bits indicates any one of the following: whether the first device is allowed to perform the target transmission in the corresponding second time unit, and a third adjustment amount of the corresponding second time unit; and the third adjustment amount is used for adjusting the power spectral density.

Optionally, in this embodiment of this application, the second time unit may be any of the following: a subframe, a wireless frame, a slot, a mini-slot, an OFDM symbol, and the like.

Optionally, in this embodiment of this application, N is an integer multiple of Y It can be understood that a plurality of groups of Y bits may be included in the N bits.

The following uses any group of the plurality of groups of Y bits as an example for description.

### Case 1

Optionally, in this embodiment of this application, the Y bits in the N bits indicate whether the first device is allowed to perform the target transmission in the corresponding second time unit; and the first adjustment amount includes S sub-adjustment amounts, each sub-adjustment amount corresponds to at least one second time unit, and S is a positive integer. Optionally, the foregoing step 101 may be implemented by using the following step 101f or step 101g.

Step 101f: In a case that the Y bits indicate that the first device is allowed to perform the target transmission in the corresponding second time unit, the first device determines a first sub-adjustment amount as a fifth preset value.

In this embodiment of this application, because the Y bits indicate whether the first device is allowed to perform the target transmission in the corresponding second time unit, that is, the Y bits indicate that the first device is allowed to perform the target transmission in the corresponding second time unit, or the first device is not allowed to perform the target transmission in the corresponding second time unit. In other words, the Y bits indicate one of the two cases, and therefore, the indication may be made through 1 bit. That is, in this case, Y may be equal to 1.

Optionally, in this embodiment of this application, the fifth preset value psdDeltaValue5 may be a preset value specified by a protocol, a preset value configured by the network side device, a preset value preconfigured by the network side device, or a preset value defaulted by the first device. The fifth preset value psdDeltaValue5 is greater than 0.

In this embodiment of this application, the first sub-adjustment amount is a sub-adjustment amount that is in the S sub-adjustment amounts and that corresponds to the same second time unit as the Y bits.

In this embodiment of this application, if the Y bits indicate that the first device is allowed to perform the target transmission in the corresponding second time unit, it can be considered that Uu communication does not exist in the second time unit (transmission resources of the Uu communication at least partially overlap with transmission resources of the target transmission). Therefore, the first device may determine the first sub-adjustment amount as the fifth preset value, so that a power spectral density corresponding to the second time unit is larger among target power spectral densities determined based on the first sub-adjustment amount.

It can be learned that because the first device may determine the first sub-adjustment amount as the fifth preset value in a case that the Y bits indicate that the first device is allowed to perform the target transmission in the corresponding second time unit, the power spectral density of target power spectral densities that corresponds to the second time unit is larger. In this way, transmission performance of the target transmission may be improved.

Step 101g: In a case that the Y bits indicate that the first device is not allowed to perform the target transmission in the corresponding second time unit, the first device determines the first sub-adjustment amount as a sixth preset value.

In this embodiment of this application, the fifth preset value is greater than the sixth preset value.

Optionally, in this embodiment of this application, the sixth preset value psdDeltaValue6 may be a preset value specified by a protocol, a preset value configured by the network side device, a preset value preconfigured by the network side device, or a preset value defaulted by the first device. The sixth preset value psdDeltaValue6 is greater than 0.

In this embodiment of this application, if the Y bits indicate that the first device is not allowed to perform the target transmission in the corresponding second time unit, it can be considered that Uu communication exists in the second time unit (transmission resources of the Uu communication at least partially overlap with transmission resources of the target transmission). Therefore, the first device may determine the first sub-adjustment amount as the sixth preset value, so that a power spectral density corresponding to the second time unit is smaller among target power spectral densities determined based on the first sub-adjustment amount.

It can be learned that because the first device may determine the first sub-adjustment amount as the sixth preset value in a case that the Y bits indicate that the first device is not allowed to perform the target transmission in the corresponding second time unit, the power spectral density of target power spectral densities that corresponds to the second time unit is smaller. In this way, interference to the Uu communication (transmission resources of the Uu communication at least partially overlap with transmission resources of the target transmission) may be reduced.

For example, it is assumed that the N bits include 4 bits, bit 1 and bit 2 in the 4 bits indicate that the first device is allowed to perform the target transmission in the corresponding second time unit (for example, slots: slot 0 and slot 1), and bit 3 and bit 4 in the 4 bits indicate that the first device is not allowed to perform the target transmission in the corresponding second time units (for example, slots: slot 2 and slot 3). Details are shown in Table 1.

TABLE 1

| slot | slot 0 | slot 1 | slot 2 | slot 3 |
|---|---|---|---|---|
| Whether the first device is allowed to | Y | Y | N | N |
| perform the target transmission | | | | |

In this case, the first device may determine a first sub-adjustment amount 1 (the first sub-adjustment amount 1 corresponds to slot 0 and slot 1) as the fifth preset value, and determine a first sub-adjustment amount 2 (the first sub-adjustment amount 2 corresponds to slot 2 and slot 3) as the sixth preset value, so that among the target power spectral densities, a power spectral density corresponding to slot 0 and slot 1 is larger, and a power spectral density corresponding to slot 2 and slot 3 is smaller.

### Case 2

Optionally, in this embodiment of this application, the Y bits in the N bits indicate the third adjustment amount of the corresponding second time unit; and the first adjustment amount includes S sub-adjustment amounts, each sub-adjustment amount corresponds to at least one second time unit, and S is a positive integer. Optionally, the foregoing step 101 may be implemented by using the following step 101h.

Step 101h: The first device determines a second sub-adjustment amount as the third adjustment amount.

In this embodiment of this application, the second sub-adjustment amount is a sub-adjustment amount that is in the S sub-adjustment amounts and that corresponds to the same second time unit as the Y bits.

In this embodiment of this application, because the Y bits indicate the third adjustment amount of the corresponding second time unit, and the third adjustment amount of the corresponding second time unit may be one of a plurality of cases, that is, the Y bits indicate one of the plurality of cases, the indication may be made through a plurality of bits. That is, in this case, Y may be greater than 1.

It can be learned that because the first device may directly determine the third adjustment amount as the second sub-adjustment amount in a case that the Y bits indicate the third adjustment amount of the corresponding second time unit, the power spectral density of the target power spectral densities that corresponds to the second time unit determined based on the second sub-adjustment amount is the proper power spectral density. In this way, the transmission performance of the target transmission may be improved in a case of ensuring low interference to Uu communication (transmission resources of the Uu communication at least partially overlap with transmission resources of the target transmission).

For example, it is assumed that the N bits include 4 bits, bit 1 and bit 2 in the 4 bits indicate a third adjustment amount psdDelta1 in the corresponding second time unit (for example, slot 0 and slot 1), bit 3 in the 4 bits indicates a third adjustment amount psdDelta2 in the corresponding second time unit (for example, slot 2), and bit 4 in the 4 bits indicates a third adjustment amount psdDelta3 in the corresponding second time unit (for example, slot 3). Details are shown in Table 2.

TABLE 2

| slot | slot 0 | slot 1 | slot 2 | slot 3 |
|---|---|---|---|---|
| Third adjustment amount | psdDelta1 | psdDelta1 | psdDelta2 | psdDelta3 |
| of the corresponding | | | | |
| second time unit | | | | |

In this case, the first device may determine a second sub-adjustment amount 1 (the second sub-adjustment amount 1 corresponds to slot 0 and slot 1) as the third adjustment amount psdDelta1, determine a second sub-adjustment amount 2 (the second sub-adjustment amount 2 corresponds to slot 2) as the third adjustment amount psdDelta2, and determine a second sub-adjustment amount 3 (the second sub-adjustment amount 3 corresponds to slot 3) as the third adjustment amount psdDelta3.

The following uses two groups of the plurality of groups of Y bits as an example for description.

### Case 3

Optionally, in this embodiment of this application, a first group of Y bits in the N bits indicates whether the first device is allowed to perform the target transmission in the corresponding second time unit, and a second group of Y bits in the N bits indicates the third adjustment amount of the corresponding second time unit. The first adjustment amount includes S sub-adjustment amounts, each sub-adjustment amount corresponds to at least one second time unit, and S is a positive integer.

It should be noted that for the description in which the first device determines the sub-adjustment amount that is in the S sub-adjustment amounts and that corresponds to the same second time unit as the first group of Y bits, refer to the description in Case 1 in the foregoing embodiment; and for the description in which the first device determines the sub-adjustment amount that is in the S sub-adjustment amounts and that corresponds to the same second time unit as the second group of Y bits, refer to the description in Case 2 in the foregoing embodiment. Details are not described herein again in this embodiment of this application.

### Example 5

Optionally, in this embodiment of this application, the first information includes at least one of the following: the service volume of the service to be/being transmitted in the target Uu transmission, the priority of the target Uu transmission, or the service volume of the target service to be/being transmitted in the target Uu transmission. Optionally, the foregoing step 101 may be implemented by using the following step 101i and step 101j.

Step 101i: In a case that the first information is less than a third threshold, the first device determines the first adjustment amount as a seventh preset value.

Optionally, in this embodiment of this application, the seventh preset value psdDeltaValue7 may be a preset value specified by a protocol, a preset value configured by the network side device, a preset value preconfigured by the network side device, or a preset value defaulted by the first device. The seventh preset value psdDeltaValue7 is greater than 0.

In this embodiment of this application, if at least one of the service volume of the service to be/being transmitted in the target Uu transmission, the priority of the target Uu transmission, or the service volume of the target service to be/being transmitted in the target Uu transmission is less than the third threshold, it can be considered that the target Uu communication may not be important. Therefore, the first device may determine the first adjustment amount as the seventh preset value, so that the target power spectral density determined based on the first adjustment amount is large.

It can be learned that because the first device may determine the first adjustment amount as the seventh preset value in a case that the target Uu communication is not important, the target power spectral density determined based on the first adjustment amount is large. In this way, transmission performance of the target transmission may be improved.

Step 101j: In a case that the first information is greater than or equal to the third threshold, the first device determines the first adjustment amount as an eighth preset value.

In this embodiment of this application, the seventh preset value is greater than the eighth preset value.

Optionally, in this embodiment of this application, the eighth preset value psdDeltaValue8 may be a preset value specified by a protocol, a preset value configured by the network side device, a preset value preconfigured by the network side device, or a preset value defaulted by the first device. The eighth preset value psdDeltaValue8 is less than 0.

In this embodiment of this application, if at least one of the service volume of the service to be/being transmitted in the target Uu transmission, the priority of the target Uu transmission, or the service volume of the target service to be/being transmitted in the target Uu transmission is greater than or equal to the third threshold, it can be considered that the target Uu communication may be relatively important. Therefore, the first device may determine the first adjustment amount as the eighth preset value, so that the target power spectral density determined based on the first adjustment amount is small.

It can be learned that because the first device may determine the first adjustment amount as the eighth preset value in a case that the target Uu communication is relatively important, the target power spectral density determined based on the first adjustment amount is small. In this way, interference to the target Uu communication may be reduced.

### Example 6

Optionally, in this embodiment of this application, the first information includes the first time unit sequence; and the first adjustment amount includes S sub-adjustment amounts, each sub-adjustment amount corresponds to at least one second time unit, and S is a positive integer. Optionally, the foregoing step 101 may be implemented by using the following step 101k.

Step 101k: The first device determines a third sub-adjustment amount as a ninth preset value, and determines a fourth sub-adjustment amount as a tenth preset value.

In this embodiment of this application, the ninth preset value is greater than the tenth preset value; the third sub-adjustment amount is a sub-adjustment amount of the S sub-adjustment amounts that corresponds to the X first time units; and the fourth sub-adjustment amount is a sub-adjustment amount other than the third sub-adjustment amount of the S sub-adjustment amounts.

Optionally, in this embodiment of this application, the ninth preset value psdDeltaValue9 may be a preset value specified by a protocol, a preset value configured by the network side device, a preset value preconfigured by the network side device, or a preset value defaulted by the first device. The ninth preset value psdDeltaValue9 is greater than 0.

Optionally, in this embodiment of this application, the tenth preset value psdDeltaValue10 may be a preset value specified by a protocol, a preset value configured by the network side device, a preset value preconfigured by the network side device, or a preset value defaulted by the first device. The tenth preset value psdDeltaValue10 is less than 0.

Certainly, there may also be a case in which a frequency range occupied by the target transmission overlaps with a frequency range corresponding to at least one Uu cell, and the following uses an example for description.

Optionally, in this embodiment of this application, a frequency range occupied by the target transmission overlaps with a frequency range corresponding to M Uu cells; the first adjustment amount includes M fifth sub-adjustment amounts, and each fifth sub-adjustment amount corresponds to one Uu cell; the first power spectral density information includes M pieces of first sub-power spectral density information, each first sub-power spectral density information corresponds to one Uu cell, and each fifth sub-adjustment amount corresponds to one piece of first sub-power spectral density information; the target power spectral density includes M first power spectral densities; and M is a positive integer. Optionally, the foregoing step 102 may be implemented by using the following step 102a.

Step 102a: For each of the M fifth sub-adjustment amounts, the first device determines one first power spectral density based on one fifth sub-adjustment amount and corresponding first sub-power spectral density information, to determine the M first power spectral densities.

In this embodiment of this application, each of the M first power spectral densities corresponds to one Uu cell.

Optionally, in this embodiment of this application, the foregoing step 103 may be implemented by using at least one of the following step 103a to step 103c.

Step 103a: The first device performs the target transmission with the second device based on a power spectral density, with a lowest value, of T first power spectral densities.

In this embodiment of this application, the T first power spectral densities are power spectral densities of the M first power spectral densities, and T is a positive integer.

Optionally, in this embodiment of this application, T is less than or equal to M.

Optionally, in this embodiment of this application, T may be equal to M. That is, the first device may perform the target transmission with the second device based on a power spectral density, with a lowest value, of M first power spectral densities within a frequency range corresponding to all Uu cells.

Step 103b: The first device performs the target transmission with the second device not within a frequency range corresponding to Q Uu cells.

In this embodiment of this application, the Q Uu cells are Uu cells corresponding to the first power spectral densities less than a fourth threshold of the M Uu cells, and Q is a positive integer.

Optionally, in this embodiment of this application, T may be equal to M. That is, the first device may perform the target transmission with the second device based on a power spectral density, with a lowest value, of M first power spectral densities within a frequency range corresponding to M-Q Uu cells. The M-Q Uu cells are Uu cells other than the Q Uu cells of the M Uu cells.

Step 103c: The first device performs the target transmission with the second device only within a frequency range corresponding to L Uu cells.

In this embodiment of this application, the L Uu cells are Uu cells corresponding to the first power spectral densities greater than or equal to a fifth threshold of the M Uu cells, and L is a positive integer.

Optionally, in this embodiment of this application, T may be equal to M. That is, the first device may perform the target transmission with the second device based on a power spectral density, with a lowest value, of M first power spectral densities only within a frequency range corresponding to L Uu cells.

FIG. 5 is a flowchart of a transmission method according to an embodiment of this application. As shown in FIG. 5, the transmission method provided in this embodiment of this application may include the following step 401.

Step 401: A target device sends signaling to a first device.

In this embodiment of this application, the signaling carries first information, the first information is used for determining a first adjustment amount, and the first adjustment amount is used for adjusting a power spectral density of the first device, to make the first device perform target transmission with a second device.

Optionally, in this embodiment of this application, the signaling may include at least one of the following: RRC signaling, MAC signaling, or physical layer signaling.

Optionally, in this embodiment of this application, the first information includes at least one of the following:
a second adjustment amount;
a first index;
a first bitmap;
a service volume of a service to be/being transmitted by target Uu transmission;
a priority of the target Uu transmission;
a service volume of a target service to be/being transmitted in the target Uu transmission; or
a first time unit sequence.

The second adjustment amount is used for adjusting the power spectral density; the first index has a mapping relationship with the second adjustment amount; the first bitmap includes N bits; time domain resources of the target Uu transmission at least partially overlap with time domain resources of the target transmission; the target service is a service with a priority greater than or equal to a predetermined priority; the first time unit sequence includes X first time units; and N and X are positive integers.

Optionally, in this embodiment of this application, the first adjustment amount is used for determining a target power spectral density with first power spectral density information, so that the first device may perform the target transmission with the second device based on the target power spectral density. The first power spectral density information is related to the power spectral density of the first device.

It should be noted that for description of determining the target power spectral density, refer to the description in the foregoing embodiment. Details are not described herein again in this embodiment of this application.

In this embodiment of this application, the target device is any one of the following: a second device, a network side device, and a third device.

Optionally, in this embodiment of this application, the second device may be any one of the following: an access point and a terminal. The access point may be a micro base station, a pico base station, or the like.

Optionally, in this embodiment of this application, the third device may be a device related to Uu communication (transmission resources of the Uu communication at least partially overlap with transmission resources of the target transmission), or an unrelated device.

According to the transmission method provided in this embodiment of this application, the target device may send the signaling carrying the first information to the first device, the first information is used for determining a first adjustment amount, the first adjustment amount is used for adjusting the power spectral density of the first device, to perform the target transmission with the second device, and the target device is any one of the following: the second device, the network side device, and the third device. Because the target device may indicate first information to the first device, the first device may determine a proper first adjustment amount based on the first information, and determine a proper target power spectral density based on the proper first adjustment amount and the first power spectral density information. In this way, the first device may perform target transmission with the second device based on the proper target power spectral density, to improve the transmission performance of the target transmission in a case of ensuring low interference to Uu communication (transmission resources of the Uu communication at least partially overlap with transmission resources of the target transmission).

The transmission method provided in this embodiment of this application may be executed by a transmission apparatus. The transmission apparatus provided in the embodiments of this application is described by using an example in which the transmission apparatus performs the transmission method.

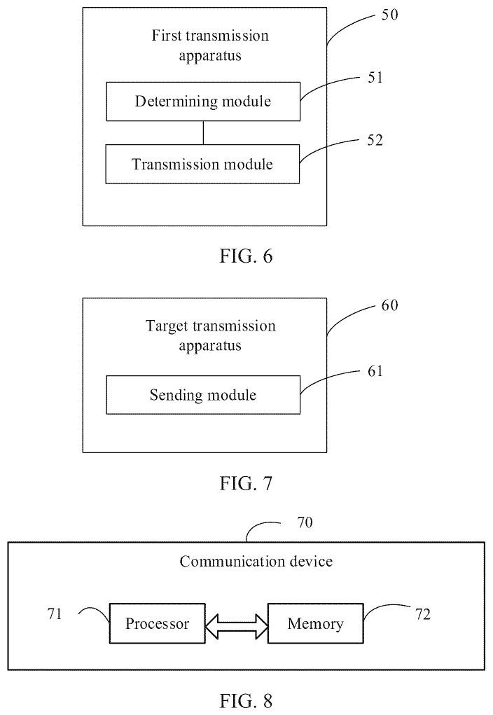

FIG. 6 is a schematic diagram of a structure of a transmission apparatus according to an embodiment of this application, and the transmission apparatus is a first transmission apparatus. As shown in FIG. 6, the first transmission apparatus 50 may include: a determining module 51 and a transmission module 52.

The determining module 51 is configured to: determine a first adjustment amount based on first information, the first adjustment amount being used for adjusting a power spectral density of the first transmission apparatus 50; and determine a target power spectral density based on the first adjustment amount and first power spectral density information, the first power spectral density information being related to the power spectral density of the first transmission apparatus 50. The transmission module 52 is configured to perform target transmission with a second transmission apparatus based on the target power spectral density determined by the determining module 51. The first information satisfies at least one of the following: being obtained based on a result of measurement performed on a transmission resource of the target transmission, or being obtained by using information carried by signaling.

In a possible implementation, the first information is obtained based on the result of measurement performed on the transmission resource of the target transmission. The first transmission apparatus 50 provided in this embodiment of this application may further include a measurement module. The measurement module is configured to perform measurement on a frequency domain resource of the target transmission, to obtain the first information.

In a possible implementation, the first information includes at least one of the following: the RSSI of the frequency domain resource of the target transmission; the CBR of the frequency domain resource of the target transmission; beam matching information between the first transmission apparatus 50 and a network side device; the signal strength of the SRS; the signal strength of the SSB; or the signal strength of the CSI-RS.

In a possible implementation, the first information includes at least one of the following: the RSSI of the frequency domain resource of the target transmission, the CBR of the frequency domain resource of the target transmission, the signal strength of the SRS, the signal strength of the SSB, or the signal strength of the CSI-RS. The determining module 51 is configured for any one of the following: in a case that the first information is less than or equal to a first threshold, determining the first adjustment amount as a first preset value; and in a case that the first information is greater than or equal to a second threshold, determining the first adjustment amount as a second preset value. The first preset value is greater than the second preset value.

In a possible implementation, the first information is the beam matching information; and the beam matching information indicates that an interference of the first transmission apparatus 50 to the network side device in a first beam direction is greater than an interference of the first transmission apparatus 50 to the network side device in a second beam direction. The determining module 51 is configured for any one of the following: in a case that a beam direction of the target transmission is the first beam direction, determining the first adjustment amount as a third preset value; and in a case that the beam direction of the target transmission is the second beam direction, determining the first adjustment amount as a fourth preset value. The third preset value is less than the fourth preset value.

In a possible implementation, the first information is obtained by using the information carried by signaling. The first transmission apparatus 50 provided in this embodiment of this application may further include a receiving module. The receiving module is configured to receive the signaling sent by a target transmission apparatus, and the signaling carries the first information. The target transmission apparatus is any one of the following: the second transmission apparatus, a network side device, and a third transmission apparatus.

In a possible implementation, the first information includes at least one of the following: a second adjustment amount; a first index; a first bitmap; a service volume of a service to be/being transmitted by target Uu transmission; a priority of the target Uu transmission; a service volume of a target service to be/being transmitted in the target Uu transmission; or a first time unit sequence. The second adjustment amount is used for adjusting the power spectral density; the first index has a mapping relationship with the second adjustment amount; the first bitmap includes N bits; time domain resources of the target Uu transmission at least partially overlap with time domain resources of the target transmission; the target service is a service with a priority greater than or equal to a predetermined priority; the first time unit sequence includes X first time units; and N and X are positive integers.

In a possible implementation, the first information includes any one of the following: a second adjustment amount and a first index. The determining module 51 is configured to determine the first adjustment amount as the second adjustment amount.

In a possible implementation, the first information includes the first bitmap; and every Y bits in the N bits corresponds to one second time unit, and Y is a positive integer. Every Y bits indicates any one of the following: whether the first transmission apparatus 50 is allowed to perform the target transmission in the corresponding second time unit, and a third adjustment amount of the corresponding second time unit; and the third adjustment amount is used for adjusting the power spectral density.

In a possible implementation, the Y bits in the N bits indicate whether the first transmission apparatus 50 is allowed to perform the target transmission in the corresponding second time unit; and the first adjustment amount includes S sub-adjustment amounts, each sub-adjustment amount corresponds to at least one second time unit, and S is a positive integer. The determining module 51 is configured for any one of the following: in a case that the Y bits indicate that the first transmission apparatus 50 is allowed to perform the target transmission in the corresponding second time unit, determining a first sub-adjustment amount as a fifth preset value; and in a case that the Y bits indicate that the first transmission apparatus 50 is not allowed to perform the target transmission in the corresponding second time unit, determining the first sub-adjustment amount as a sixth preset value. The fifth preset value is greater than the sixth preset value; and the first sub-adjustment amount is a sub-adjustment amount that is in the S sub-adjustment amounts and that corresponds to the same second time unit as the Y bits.

In a possible implementation, the Y bits in the N bits indicate the third adjustment amount of the corresponding second time unit; and the first adjustment amount includes S sub-adjustment amounts, each sub-adjustment amount corresponds to at least one second time unit, and S is a positive integer. The determining module 51 is configured to determine a second sub-adjustment amount as the third adjustment amount. The second sub-adjustment amount is a sub-adjustment amount that is in the S sub-adjustment amounts and that corresponds to the same second time unit as the Y bits.

In a possible implementation, the first information includes at least one of the following: the service volume of the service to be/being transmitted by target Uu transmission, the priority of the target Uu transmission, or the service volume of the target service to be/being transmitted in the target Uu transmission. The determining module 51 is configured for any one of the following: in a case that the first information is less than a third threshold, determining the first adjustment amount as a seventh preset value; and in a case that the first information is greater than or equal to the third threshold, determining the first adjustment amount as an eighth preset value. The seventh preset value is greater than the eighth preset value.

In a possible implementation, the first information includes the first time unit sequence; and the first adjustment amount includes S sub-adjustment amounts, each sub-adjustment amount corresponds to at least one second time unit, and S is a positive integer. The determining module 51 is configured to: determine a third sub-adjustment amount as a ninth preset value, and determine a fourth sub-adjustment amount as a tenth preset value. The ninth preset value is greater than the tenth preset value; the third sub-adjustment amount is a sub-adjustment amount of the S sub-adjustment amounts that corresponds to the X first time units; and the fourth sub-adjustment amount is a sub-adjustment amount other than the third sub-adjustment amount of the S sub-adjustment amounts.

In a possible implementation, a frequency range occupied by the target transmission overlaps with a frequency range corresponding to M Uu cells; the first adjustment amount includes M fifth sub-adjustment amounts, and each fifth sub-adjustment amount corresponds to one Uu cell; the first power spectral density information includes M pieces of first sub-power spectral density information, each first sub-power spectral density information corresponds to one Uu cell, and each fifth sub-adjustment amount corresponds to one piece of first sub-power spectral density information; the target power spectral density includes M first power spectral densities; and M is a positive integer. The determining module 51 is configured to: for each of the M fifth sub-adjustment amounts, determine one first power spectral density based on one fifth sub-adjustment amount and corresponding first sub-power spectral density information, to determine the M first power spectral densities. Each of the M first power spectral densities corresponds to one Uu cell.

In a possible implementation, the transmission module 52 is configured for at least one of the following: performing the target transmission with the second transmission apparatus based on a power spectral density, with a lowest value, of T first power spectral densities; performing the target transmission with the second transmission apparatus not within a frequency range corresponding to Q Uu cells; or performing the target transmission with the second transmission apparatus only within a frequency range corresponding to L Uu cells. The T first power spectral densities are power spectral densities of the M first power spectral densities, and T is a positive integer; the Q Uu cells are Uu cells corresponding to the first power spectral densities less than a fourth threshold of the M Uu cells, and Q is a positive integer; and the L Uu cells are Uu cells corresponding to the first power spectral densities greater than or equal to a fifth threshold of the M Uu cells, and L is a positive integer.

In a possible implementation, the first adjustment amount includes at least one of the following: a power spectral density adjustment amount or a power spectral density limit adjustment amount.

In a possible implementation, the first power spectral density information includes at least one of the following: a second power spectral density; a lowest value of power spectral density limit of the first transmission apparatus 50; or a highest value of the power spectral density limit of the first transmission apparatus 50. The second power spectral density is a power spectral density of latest transmission between the first transmission apparatus 50 and the second transmission apparatus.

According to the transmission apparatus provided in this embodiment of this application, the transmission apparatus is a first transmission apparatus. Because the first information is obtained based on the result of measurement performed on the transmission resource of the target transmission, and the result is related to Uu communication (transmission resources of the Uu communication at least partially overlap with transmission resources of the target transmission), the first transmission apparatus may determine a proper first adjustment amount based on the first information, and determine a proper target power spectral density based on the proper first adjustment amount and first power spectral density information. In this way, the first transmission apparatus may perform target transmission with the second transmission apparatus based on the proper target power spectral density, to reduce interference to the Uu communication; and/or because the first information is obtained by using the information carried by signaling, that is, the first transmission apparatus may determine a proper first adjustment amount based on indication of the information, and determine a proper target power spectral density based on the proper first adjustment amount and the first power spectral density information. In this way, the first transmission apparatus may perform target transmission with the second transmission apparatus based on the proper target power spectral density, to reduce interference to the Uu communication. In this way, transmission performance of the target transmission may be improved on the premise of ensuring performance of the Uu communication.

The transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a network attached storage (NAS), and the like. This is not specifically limited in this embodiment of this application.

The transmission apparatus provided in this embodiment of this application can implement the processes implemented in the method embodiments in FIG. 2 to FIG. 4, and a same technical effect can be achieved. To avoid repetition, details are not described herein again.

FIG. 7 is a schematic diagram of a structure of a transmission apparatus according to an embodiment of this application, and the transmission apparatus is a target transmission apparatus. As shown in FIG. 7, the target transmission apparatus 60 may include a sending module 61.

The sending module 61 is configured to send signaling to a first transmission apparatus, the signaling carries first information, and the first information is used for determining a first adjustment amount, where the first adjustment amount is used for adjusting a power spectral density of the first transmission apparatus, to perform target transmission with a second transmission apparatus, and the target transmission apparatus is any one of the following: the second transmission apparatus, a network side device, and a third transmission apparatus.

In a possible implementation, the first information includes at least one of the following: a second adjustment amount; a first index; a first bitmap; a service volume of a service to be/being transmitted by target Uu transmission; a priority of the target Uu transmission; a service volume of a target service to be/being transmitted in the target Uu transmission; or a first time unit sequence. The second adjustment amount is used for adjusting the power spectral density; the first index has a mapping relationship with the second adjustment amount; the first bitmap includes N bits; time domain resources of the target Uu transmission at least partially overlap with time domain resources of the target transmission; the target service is a service with a priority greater than or equal to a predetermined priority; the first time unit sequence includes X first time units; and N and X are positive integers.

According to the transmission apparatus provided in this embodiment of this application, because the target transmission apparatus may indicate first information to the first transmission apparatus, the first transmission apparatus may determine a proper first adjustment amount based on the first information, and determine a proper target power spectral density based on the proper first adjustment amount and the first power spectral density information. In this way, the first transmission apparatus may perform target transmission with the second transmission apparatus based on the proper target power spectral density, to reduce interference to the Uu communication (transmission resources of the Uu communication at least partially overlap with transmission resources of the target transmission). In this way, transmission performance of the target transmission may be improved on the premise of ensuring performance of the Uu communication.

The transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may include but is not limited to the foregoing listed types of the network side device 12, or may be a server, a network attached storage (NAS), and the like. This is not specifically limited in this embodiment of this application.

The transmission apparatus provided in this embodiment of this application can implement the processes implemented in the method embodiment of FIG. 5 and achieve a same technical effect. To avoid repetition, details are not described herein again.

Optionally, in this embodiment of this application, as shown in FIG. 8, an embodiment of this application further provides a communication device 70, including a processor 71 and a memory 72. The memory 72 stores a program or an instruction that can be run on the processor 71. For example, when the communication device 70 is a terminal, the program or the instruction is executed by the processor 71 to implement the steps of the foregoing transmission method embodiments, and a same technical effect can be achieved. In a case that the communication device 70 is a network side device, when the program or the instruction is executed by the processor 71, the steps of the foregoing transmission method embodiments are implemented, and a same technical effect can be achieved. To avoid repetition, details are not described herein again.

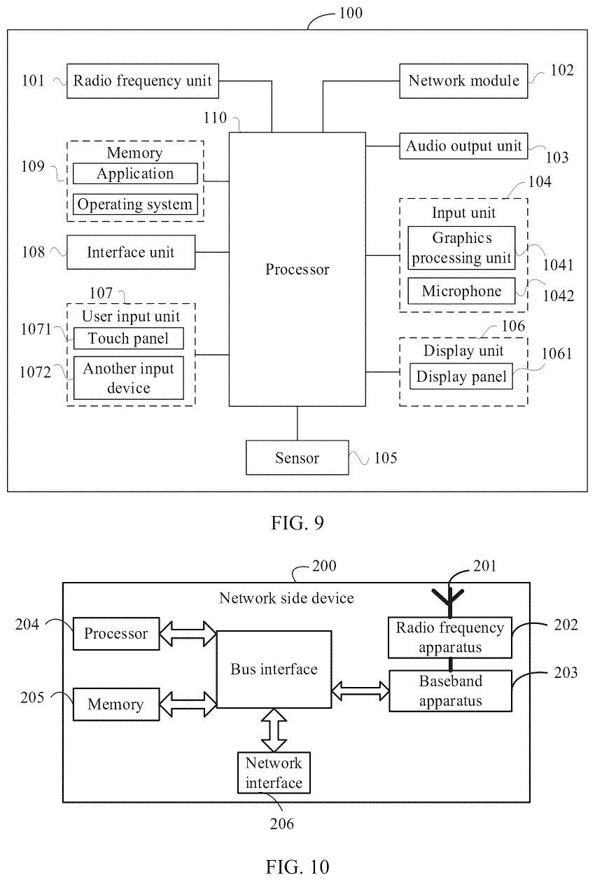

An embodiment of this application further provides a terminal, including a processor and a communication interface. The processor is configured to: determine a first adjustment amount based on first information, the first adjustment amount being used for adjusting a power spectral density of a first device; and determine a target power spectral density based on the first adjustment amount and first power spectral density information, the first power spectral density information being related to the power spectral density of the first device. The communication interface is configured to perform target transmission with a second device based on the target power spectral density. The first information satisfies at least one of the following: being obtained based on a result of measurement performed on a transmission resource of the target transmission, or being obtained by using information carried by signaling. Alternatively, the communication interface is configured to send signaling to a first terminal, the signaling carries first information, and the first information is used for determining a first adjustment amount. The first adjustment amount is used for adjusting a power spectral density of the first terminal, to perform target transmission with a second terminal, and the terminal is any one of the following: the second terminal and a third terminal. The terminal embodiment is corresponding to the method embodiment on the terminal side, each implementation process and implementation of the method embodiment can be applied to the terminal embodiment, and a same technical effect can be achieved. Optionally, FIG. 9 is a schematic diagram of a hardware structure of a terminal according to an embodiment of this application.

The terminal 100 includes but is not limited to at least a part of components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the terminal 100 may further include a power supply (such as a battery) that supplies power to each component. The power supply may be logically connected to the processor 110 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 104 may include a graphics processing unit (GPU) 1041 and a microphone 1042. The graphics processing unit 1041 processes image data of a static picture or a video obtained by an image capture apparatus (for example, a camera) in a video capture mode or an image capture mode. The display unit 106 may include a display panel 1061, and the display panel 1061 may be configured in a form of a liquid crystal display, an organic light-emitting diode, or the like. The user input unit 107 includes at least one of a touch panel 1071 or another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 101 may transmit the downlink data to the processor 110 for processing. In addition, the radio frequency unit 101 may send uplink data to the network side device. Generally, the radio frequency unit 101 includes but is not limited to an antenna, an amplifier, a transceiver, a coupler, a low noise amplifier, a duplexer, and the like.

The memory 109 may be configured to store a software program or an instruction and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may be a volatile memory or a non-volatile memory, or the memory 109 may include a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 109 in this embodiment of this application includes but is not limited to these memories and any memory of another proper type.

The processor 110 may include one or more processing units. Optionally, an application processor and a modem processor are integrated into the processor 110. The application processor mainly processes an operating system, a user interface, an application, and the like. The modem processor mainly processes a wireless communication signal, for example, a baseband processor. It may be understood that, alternatively, the modem processor may not be integrated into the processor 110.

In a possible implementation, the processor 110 is configured to: determine a first adjustment amount based on first information, the first adjustment amount being used for adjusting a power spectral density of a first terminal; and determine a target power spectral density based on the first adjustment amount and first power spectral density information, the first power spectral density information being related to the power spectral density of the first terminal.

The radio frequency unit 101 is configured to perform target transmission with the second device based on the target power spectral density.

The first information satisfies at least one of the following: being obtained based on a result of measurement performed on a transmission resource of the target transmission, or being obtained by using information carried by signaling.

According to the terminal provided in this embodiment of this application, the terminal is a first terminal. Because the first information is obtained based on the result of measurement performed on the transmission resource of the target transmission, and the result is related to Uu communication (transmission resources of the Uu communication at least partially overlap with transmission resources of the target transmission), the first terminal may determine a proper first adjustment amount based on the first information, and determine a proper target power spectral density based on the proper first adjustment amount and first power spectral density information. In this way, the first terminal may perform target transmission with the second terminal based on the proper target power spectral density, to reduce interference to the Uu communication; and/or because the first information is obtained by using the information carried by signaling, that is, the first terminal may determine a proper first adjustment amount based on indication of the information, and determine a proper target power spectral density based on the proper first adjustment amount and the first power spectral density information. In this way, the first terminal may perform target transmission with the second terminal based on the proper target power spectral density, to reduce interference to the Uu communication. In this way, transmission performance of the target transmission may be improved on the premise of ensuring performance of the Uu communication.

Optionally, in this embodiment of this application, the first information is obtained based on the result of measurement performed on the transmission resource of the target transmission.

The processor 110 is further configured to perform measurement on a frequency domain resource of the target transmission, to obtain the first information.

Optionally, in this embodiment of this application, the first information includes at least one of the following: the RSSI of the frequency domain resource of the target transmission, the CBR of the frequency domain resource of the target transmission, the signal strength of the SRS, the signal strength of the SSB, or the signal strength of the CSI-RS.

The processor 110 is configured for any one of the following:
in a case that the first information is less than or equal to a first threshold, determining the first adjustment amount as a first preset value; and
in a case that the first information is greater than or equal to a second threshold, determining the first adjustment amount as a second preset value.

The first preset value is greater than the second preset value.

Optionally, in this embodiment of this application, the first information is the beam matching information; and the beam matching information indicates that an interference of the first terminal to the network side device in a first beam direction is greater than an interference of the first terminal to the network side device in a second beam direction.

The processor 110 is configured for any one of the following:
in a case that a beam direction of the target transmission is the first beam direction, determining the first adjustment amount as a third preset value; and
in a case that the beam direction of the target transmission is the second beam direction, determining the first adjustment amount as a fourth preset value.

The third preset value is less than the fourth preset value.

Optionally, in this embodiment of this application, the first information is obtained by using the information carried by signaling.

The radio frequency unit 101 is further configured to receive the signaling sent by a target terminal, and the signaling carries the first information.

The target terminal is any one of the following: a second terminal, a network side device, and a third terminal.

Optionally, in this embodiment of this application, the first information includes any one of the following: a second adjustment amount and a first index.

The processor 110 is configured to determine the first adjustment amount as the second adjustment amount.

Optionally, in this embodiment of this application, the Y bits in the N bits indicate whether the first terminal is allowed to perform the target transmission in the corresponding second time unit; and the first adjustment amount includes S sub-adjustment amounts, each sub-adjustment amount corresponds to at least one second time unit, and S is a positive integer.

The processor 110 is configured for any one of the following:
in a case that the Y bits indicate that the first terminal is allowed to perform the target transmission in the corresponding second time unit, determining a first sub-adjustment amount as a fifth preset value; and
in a case that the Y bits indicate that the first terminal is not allowed to perform the target transmission in the corresponding second time unit, determining the first sub-adjustment amount as a sixth preset value.

The fifth preset value is greater than the sixth preset value; and the first sub-adjustment amount is a sub-adjustment amount that is in the S sub-adjustment amounts and that corresponds to the same second time unit as the Y bits.

Optionally, in this embodiment of this application, the Y bits in the N bits indicate the third adjustment amount of the corresponding second time unit; and the first adjustment amount includes S sub-adjustment amounts, each sub-adjustment amount corresponds to at least one second time unit, and S is a positive integer.

The processor 110 is configured to determine a second sub-adjustment amount as the third adjustment amount.

The second sub-adjustment amount is a sub-adjustment amount that is in the S sub-adjustment amounts and that corresponds to the same second time unit as the Y bits.

Optionally, in this embodiment of this application, the first information includes at least one of the following: the service volume of the service to be/being transmitted in the target Uu transmission, the priority of the target Uu transmission, or the service volume of the target service to be/being transmitted in the target Uu transmission.

The processor 110 is configured for any one of the following:
in a case that the first information is less than a third threshold, determining the first adjustment amount as a seventh preset value; and
in a case that the first information is greater than or equal to the third threshold, determining the first adjustment amount as an eighth preset value.

The seventh preset value is greater than the eighth preset value.

Optionally, in this embodiment of this application, the first information includes the first time unit sequence; and the first adjustment amount includes S sub-adjustment amounts, each sub-adjustment amount corresponds to at least one second time unit, and S is a positive integer.

The processor 110 is configured to: determine a third sub-adjustment amount as a ninth preset value, and determine a fourth sub-adjustment amount as a tenth preset value.

The ninth preset value is greater than the tenth preset value; the third sub-adjustment amount is a sub-adjustment amount of the S sub-adjustment amounts that corresponds to the X first time units; and the fourth sub-adjustment amount is a sub-adjustment amount other than the third sub-adjustment amount of the S sub-adjustment amounts.

Optionally, in this embodiment of this application, a frequency range occupied by the target transmission overlaps with a frequency range corresponding to M Uu cells; the first adjustment amount includes M fifth sub-adjustment amounts, and each fifth sub-adjustment amount corresponds to one Uu cell; the first power spectral density information includes M pieces of first sub-power spectral density information, each first sub-power spectral density information corresponds to one Uu cell, and each fifth sub-adjustment amount corresponds to one piece of first sub-power spectral density information; the target power spectral density includes M first power spectral densities; and M is a positive integer.

The processor 110 is configured to: for each of the M fifth sub-adjustment amounts, determine one first power spectral density based on one fifth sub-adjustment amount and corresponding first sub-power spectral density information, to determine the M first power spectral densities.

Each of the M first power spectral densities corresponds to one Uu cell.

Optionally, in this embodiment of this application, the radio frequency unit 101 is configured for at least one of the following:
performing the target transmission with the second terminal based on a power spectral density, with a lowest value, of T first power spectral densities;
performing the target transmission with the second terminal not within a frequency range corresponding to Q Uu cells; or
performing the target transmission with the second terminal only within a frequency range corresponding to L Uu cells.

The T first power spectral densities are power spectral densities of the M first power spectral densities, and T is a positive integer; the Q Uu cells are Uu cells corresponding to the first power spectral densities less than a fourth threshold of the M Uu cells, and Q is a positive integer; and the L Uu cells are Uu cells corresponding to the first power spectral densities greater than or equal to a fifth threshold of the M Uu cells, and L is a positive integer.

In another possible implementation, the radio frequency unit 101 is configured to send signaling to a first terminal.

The signaling carries first information, the first information is used for determining a first adjustment amount, and the first adjustment amount is used for adjusting a power spectral density of the first terminal, to perform target transmission with a target terminal. The target terminal is any one of the following: a second terminal and a third terminal.

According to the terminal provided in this embodiment of this application, the terminal is a target terminal, and the target terminal includes any one of a second terminal and a third terminal. Because the target terminal may indicate first information to the first terminal, the first terminal may determine a proper first adjustment amount based on the first information, and determine a proper target power spectral density based on the proper first adjustment amount and the first power spectral density information. In this way, the first terminal may perform target transmission with the target terminal based on the proper target power spectral density, to reduce interference to the Uu communication (transmission resources of the Uu communication at least partially overlap with transmission resources of the target transmission). In this way, transmission performance of the target transmission may be improved on the premise of ensuring performance of the Uu communication.

An embodiment of this application further provides a network side device, including a processor and a communication interface. The communication interface is configured to send signaling to a first device, the signaling carries first information, and the first information is used for determining a first adjustment amount, where the first adjustment amount is used for adjusting a power spectral density of the first device, to perform target transmission with a network side device. The network side device may include the network side device in the target devices in the foregoing embodiment, and when the second device is an access point, the network side device may further include the second device in the foregoing embodiment. This network side device embodiment is corresponding to the foregoing method embodiment of the network side device. Each implementation process and implementation of the foregoing method embodiment may be applicable to this network side device embodiment, and a same technical effect can be achieved.

Optionally, an embodiment of this application further provides a network side device. As shown in FIG. 10, the network side device 200 includes an antenna 201, a radio frequency apparatus 202, a baseband apparatus 203, a processor 204, and a memory 205. The antenna 201 is connected to the radio frequency apparatus 202. In an uplink direction, the radio frequency apparatus 202 receives information through the antenna 201, and sends the received information to the baseband apparatus 203 for processing. In a downlink direction, the baseband apparatus 203 processes information that needs to be sent, and sends processed information to the radio frequency apparatus 202. The radio frequency apparatus 202 processes the received information, and sends processed information through the antenna 201.

In the foregoing embodiment, the method performed by the network side device may be implemented in the baseband apparatus 203. The baseband apparatus 203 includes a baseband processor.

For example, the baseband apparatus 203 may include at least one baseband board. A plurality of chips are disposed on the baseband board. As shown in FIG. 10, one chip is, for example, a baseband processor, and is connected to the memory 205 by using a bus interface, to invoke a program in the memory 205 to perform the operations of the network device shown in the foregoing method embodiment.

The network side device may further include a network interface 206, and the interface is, for example, a common public radio interface (CPRI).

Optionally, the network side device 200 in this embodiment of the present application further includes an instruction or a program that is stored in the memory 205 and that can be run on the processor 204. The processor 204 invokes the instruction or the program in the memory 205 to execute the method executed by the modules shown in FIG. 7, and a same technical effect is achieved. To avoid repetition, details are not described herein again.

An embodiment of this application further provides an access point, the access point includes a processor and a memory, and the memory stores a program or an instruction that can be run on the processor. When the program or the instruction is executed by the processor, the processes of the foregoing transmission method embodiments are implemented, and a same technical effect can be achieved. To avoid repetition, details are not described herein again.

An embodiment of this application further provides an access point, the access point includes a processor and a communication interface, where the communication interface is configured to send signaling to a first terminal, the signaling carries first information, and the first information is used for determining a first adjustment amount. The first adjustment amount is used for adjusting a power spectral density of the first terminal, to perform target transmission with the access point.

An embodiment of this application further provides a non-transitory readable storage medium. The non-transitory readable storage medium stores a program or an instruction, and the program or the instruction is executed by a processor to implement the processes of the foregoing embodiments of the transmission method, and a same technical effect can be achieved. To avoid repetition, details are not described herein again.

The processor is a processor in the terminal in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the transmission method, and a same technical effect can be achieved. To avoid repetition, details are not described herein again.

An embodiment of this application further provides a transmission system, including a first terminal and a target terminal, the first terminal may be configured to perform the steps of the transmission method, and the target terminal may be configured to perform the steps of the transmission method.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes of the foregoing transmission method embodiment, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A transmission method, comprising:
determining, by a first device, a first adjustment amount based on first information, the first adjustment amount being used for adjusting a power spectral density of the first device;
determining, by the first device, a target power spectral density based on the first adjustment amount and first power spectral density information, the first power spectral density information being related to the power spectral density of the first device; and
performing, by the first device, target transmission with a second device based on the target power spectral density, wherein
the first information satisfies at least one of the following: being obtained based on a result of measurement performed on a transmission resource of the target transmission, or being obtained by using information carried by signaling.

2. The method according to claim 1, wherein the first information is obtained based on the result of measurement performed on the transmission resource of the target transmission; and
before the determining, by a first device, a first adjustment amount based on first information, the method further comprises:
performing measurement, by the first device, on a frequency domain resource of the target transmission, to obtain the first information.

3. The method according to claim 1, wherein the first information comprises at least one of the following:
received signal strength indication (RSSI) of the frequency domain resource of the target transmission;
channel busy ratio (CBR) of the frequency domain resource;
beam matching information between the first device and a network side device;
signal strength of a sounding reference signal (SRS);
signal strength of a synchronization signal and PBCH block (SSB); or
signal strength of a channel state information reference signal (CSI-RS).

4. The method according to claim 3, wherein the first information comprises at least one of the following: the RSSI of the frequency domain resource, the CBR of the frequency domain resource; the signal strength of the SRS; the signal strength of the SSB; or the signal strength of the CSI-RS; and
the determining, by a first device, a first adjustment amount based on first information comprises any one of the following:
in a case that the first information is less than or equal to a first threshold, determining, by the first device, the first adjustment amount as a first preset value; or
in a case that the first information is greater than or equal to a second threshold, determining, by the first device, the first adjustment amount as a second preset value, wherein
the first preset value is greater than the second preset value.

5. The method according to claim 3, wherein the first information is the beam matching information; and the beam matching information indicates that an interference of the first device to the network side device in a first beam direction is greater than an interference of the first device to the network side device in a second beam direction; and
the determining, by a first device, a first adjustment amount based on first information comprises any one of the following:
in a case that a beam direction of the target transmission is the first beam direction, determining, by the first device, the first adjustment amount as a third preset value; and
in a case that the beam direction of the target transmission is the second beam direction, determining, by the first device, the first adjustment amount as a fourth preset value, wherein
the third preset value is less than the fourth preset value.

6. The method according to claim 1, wherein the first information is obtained by using the information carried by signaling; and
before the determining, by a first device, a first adjustment amount based on first information, the method further comprises:
receiving, by the first device, the signaling sent by a target device, the signaling carrying the first information, wherein
the target device is any one of the following: the second device, a network side device, and a third device.

7. The method according to claim 1, wherein the first information comprises at least one of the following:
a second adjustment amount;
a first index;
a first bitmap;
a service volume of a service to be/being transmitted by target user to network universal (Uu) transmission;
a priority of the target Uu transmission;
a service volume of a target service to be/being transmitted in the target Uu transmission; or
a first time unit sequence, wherein
the second adjustment amount is used for adjusting the power spectral density; the first index has a mapping relationship with the second adjustment amount; the first bitmap comprises N bits; time domain resources of the target Uu transmission at least partially overlap with time domain resources of the target transmission; the target service is a service with a priority greater than or equal to a predetermined priority; the first time unit sequence comprises X first time units; and N and X are positive integers.

8. The method according to claim 7, wherein the first information comprises any one of the following: the second adjustment amount and the first index; and
the determining, by a first device, a first adjustment amount based on first information comprises:
determining, by the first device, the first adjustment amount as the second adjustment amount.

9. The method according to claim 7, wherein the first information comprises the first bitmap; and every Y bits in the N bits corresponds to one second time unit, and Y is a positive integer, wherein
every Y bits indicates any one of the following: whether the first device is allowed to perform the target transmission in the corresponding second time unit, and a third adjustment amount of the corresponding second time unit; and
the third adjustment amount is used for adjusting the power spectral density.

10. The method according to claim 9, wherein the Y bits in the N bits indicate whether the first device is allowed to perform the target transmission in the corresponding second time unit; and the first adjustment amount comprises S sub-adjustment amounts, each sub-adjustment amount corresponds to at least one second time unit, and S is a positive integer; and
the determining, by a first device, a first adjustment amount based on first information comprises any one of the following:
in a case that the Y bits indicate that the first device is allowed to perform the target transmission in the corresponding second time unit, determining, by the first device, a first sub-adjustment amount as a fifth preset value; and
in a case that the Y bits indicate that the first device is not allowed to perform the target transmission in the corresponding second time unit, determining, by the first device, the first sub-adjustment amount as a sixth preset value, wherein
the fifth preset value is greater than the sixth preset value; and
the first sub-adjustment amount is a sub-adjustment amount that is in the S sub-adjustment amounts and that corresponds to the same second time unit as the Y bits.

11. The method according to claim 9, wherein the Y bits in the N bits indicate the third adjustment amount of the corresponding second time unit; and the first adjustment amount comprises S sub-adjustment amounts, each sub-adjustment amount corresponds to at least one second time unit, and S is a positive integer; and
the determining, by a first device, a first adjustment amount based on first information comprises:
determining, by the first device, a second sub-adjustment amount as the third adjustment amount, wherein
the second sub-adjustment amount is a sub-adjustment amount that is in the S sub-adjustment amounts and that corresponds to the same second time unit as the Y bits.

12. The method according to claim 7, wherein the first information comprises at least one of the following: the service volume of the service to be/being transmitted in the target Uu transmission, the priority of the target Uu transmission, or the service volume of the target service to be/being transmitted in the target Uu transmission; and
the determining, by a first device, a first adjustment amount based on first information comprises any one of the following:
in a case that the first information is less than a third threshold, determining, by the first device, the first adjustment amount as a seventh preset value; and
in a case that the first information is greater than or equal to the third threshold, determining, by the first device, the first adjustment amount as an eighth preset value, wherein
the seventh preset value is greater than the eighth preset value.

13. The method according to claim 7, wherein the first information comprises the first time unit sequence; the first adjustment amount comprises S sub-adjustment amounts, each sub-adjustment amount corresponds to at least one second time unit, and S is a positive integer; and
the determining, by a first device, a first adjustment amount based on first information comprises:
determining, by the first device, a third sub-adjustment amount as a ninth preset value, and determining a fourth sub-adjustment amount as a tenth preset value, wherein
the ninth preset value is greater than the tenth preset value; and
the third sub-adjustment amount is a sub-adjustment amount of the S sub-adjustment amounts that corresponds to the X first time units; and the fourth sub-adjustment amount is a sub-adjustment amount other than the third sub-adjustment amount of the S sub-adjustment amounts.

14. The method according to claim 1, wherein a frequency range occupied by the target transmission overlaps with a frequency range corresponding to M Uu cells; the first adjustment amount comprises M fifth sub-adjustment amounts, and each fifth sub-adjustment amount corresponds to one Uu cell; the first power spectral density information comprises M pieces of first sub-power spectral density information, each first sub-power spectral density information corresponds to one Uu cell, and each fifth sub-adjustment amount corresponds to one piece of first sub-power spectral density information; the target power spectral density comprises M first power spectral densities; and M is a positive integer; and
the determining, by the first device, a target power spectral density based on the first adjustment amount and first power spectral density information comprises:
for each of the M fifth sub-adjustment amounts, determining, by the first device, one first power spectral density based on one fifth sub-adjustment amount and corresponding first sub-power spectral density information, to determine the M first power spectral densities, wherein
each first power spectral density corresponds to one Uu cell.

15. The method according to claim 14, wherein the performing, by the first device, target transmission with a second device based on the target power spectral density comprises at least one of the following:
performing, by the first device, the target transmission with the second device based on a power spectral density, with a lowest value, of T first power spectral densities;
performing, by the first device, the target transmission with the second device not within a frequency range corresponding to Q Uu cells; or
performing, by the first device, the target transmission with the second device only within a frequency range corresponding to L Uu cells, wherein
the T first power spectral densities are power spectral densities of the M first power spectral densities, and T is a positive integer;
the Q Uu cells are Uu cells corresponding to the first power spectral densities less than a fourth threshold of the M Uu cells, and Q is a positive integer; and
the L Uu cells are Uu cells corresponding to the first power spectral densities greater than or equal to a fifth threshold of the M Uu cells, and L is a positive integer.

16. The method according to claim 1, wherein the first adjustment amount comprises at least one of the following: a power spectral density adjustment amount or a power spectral density limit adjustment amount;
or
wherein the first power spectral density information comprises at least one of the following:
a second power spectral density;
a lowest value of power spectral density limit of the first device; or
a highest value of the power spectral density limit of the first device, wherein
the second power spectral density is a power spectral density of latest transmission between the first device and the second device.

17. A transmission method, comprising:
sending, by a target device, signaling to a first device, the signaling carrying first information, and the first information being used for determining a first adjustment amount, wherein
the first adjustment amount is used for adjusting a power spectral density of the first device, to make the first device perform target transmission with a second device, and the target device is any one of the following: the second device, a network side device, and a third device.

18. The method according to claim 17, wherein the first information comprises at least one of the following:
a second adjustment amount;
a first index;
a first bitmap;
a service volume of a service to be/being transmitted in target Uu transmission;
a priority of the target Uu transmission;
a service volume of a target service to be/being transmitted in the target Uu transmission; or
a first time unit sequence, wherein
the second adjustment amount is used for adjusting the power spectral density; the first index has a mapping relationship with the second adjustment amount; the first bitmap comprises N bits; time domain resources of the target Uu transmission at least partially overlap with time domain resources of the target transmission; the target service is a service with a priority greater than or equal to a predetermined priority; the first time unit sequence comprises X first time units; and N and X are positive integers.

19. A terminal, comprising a processor and a memory, wherein the memory stores a program or an instruction that is executable on the processor, and the program or the instruction, when executed by the processor, causes the terminal to perform:
determining a first adjustment amount based on first information, the first adjustment amount being used for adjusting a power spectral density of first device;
determining a target power spectral density based on the first adjustment amount and first power spectral density information, the first power spectral density information being related to the power spectral density of the first device; and
performing target transmission with a second device based on the target power spectral density, wherein
the first information satisfies at least one of the following: being obtained based on a result of measurement performed on a transmission resource of the target transmission, or being obtained by using information carried by signaling.

20. A network side device, comprising a processor and a memory, wherein the memory stores a program or an instruction that is executable on the processor, and when the program or the instruction is executed by the processor, the steps of the transmission method according to claim 17 are implemented.
